(19) United States
(12) Patent Application Publication
(10) Pub. No.: US 2009/0043930 A1
(43) Pub. Date: Feb. 12, 2009

(54) SERIAL COMMUNICATION SYSTEM AND MONITOR DEVICE

(75) Inventors: De-Zhi Li, Shenzhen (CN); Shih-Fang Wong, Tu-Cheng (TW); Yong-Jun Deng, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, ShenZhen City (CN); HON HAI PRECISION INDUSTRY CO., LTD., Tu-Cheng (TW)

(21) Appl. No.: 11/960,718

(22) Filed: Dec. 20, 2007

(30) Foreign Application Priority Data
Aug. 6, 2007 (CN) 200710201290.6

(51) Int. Cl. G06F 13/42

(52) U.S. Cl. 710/66

(57) ABSTRACT

A serial communication system includes a first and second communication devices for transmitting first signals in a first standard with each other; a convertor for receiving and converting the first signals into second signals in a second standard; a controller for generating third signals in the second standard according to the second signals; and a processing unit for receiving the third signals and generating data corresponding to the first signals in responding the received third signals. A related monitor device is also provided.

### BACKGROUND

1. Field of the Invention

The present invention relates to monitoring devices, and particularly, to a monitor device for a serial communication system.

2. Description of Related Art

Monitor devices for serial communication are used for monitoring signals transmitted between two or more serial communication devices. Commonly, two methods are used in monitoring the communications between two serial communication devices. One method is to let one of the serial communication devices monitor the other serial communication device. The other method is to measure and record the signals transmitted between the two serial communication devices by two oscilloscopes respectively. In the first method, only one serial communication device is being monitored. In the second method, each device is monitored separately, however, timing data, between the two devices, cannot be monitored.

Therefore an improved monitoring device for monitoring a serial communication system is needed to address the aforementioned deficiency and inadequacies.

### SUMMARY

A serial communication system includes a first and second communication devices for transmitting first signals in a first standard; a convertor for receiving and converting the first signals into second signals in a second standard; a controller for generating third signals in the second standard according to the second signals; and a processing unit for receiving the third signals and generating data corresponding to the first signals in responding the received third signals. A related monitor device is also provided.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a block diagram showing a serial communication system in accordance with an exemplary embodiment;

FIG. 2 is a schematic diagram showing a structure of the serial communication system of FIG. 1; and;

FIG. 3 is a schematic diagram showing a transmitting timing of signals transmitted and monitored by the serial communication system of FIG. 1.

### DETAILED DESCRIPTION OF THE EMBODIMENTS

Reference will now be made to the drawings to describe a preferred embodiment of the present serial communication system.

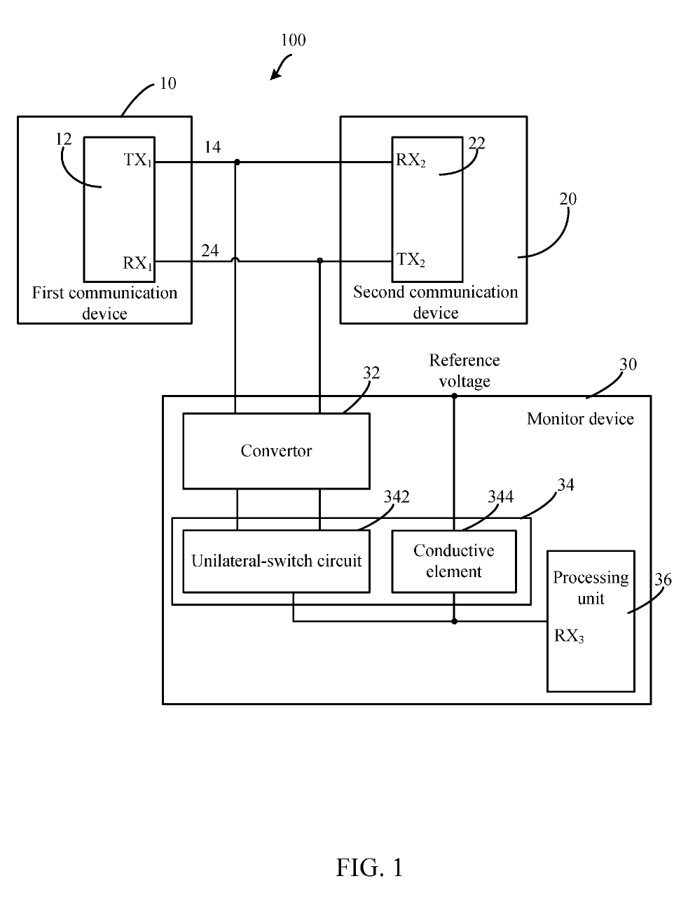

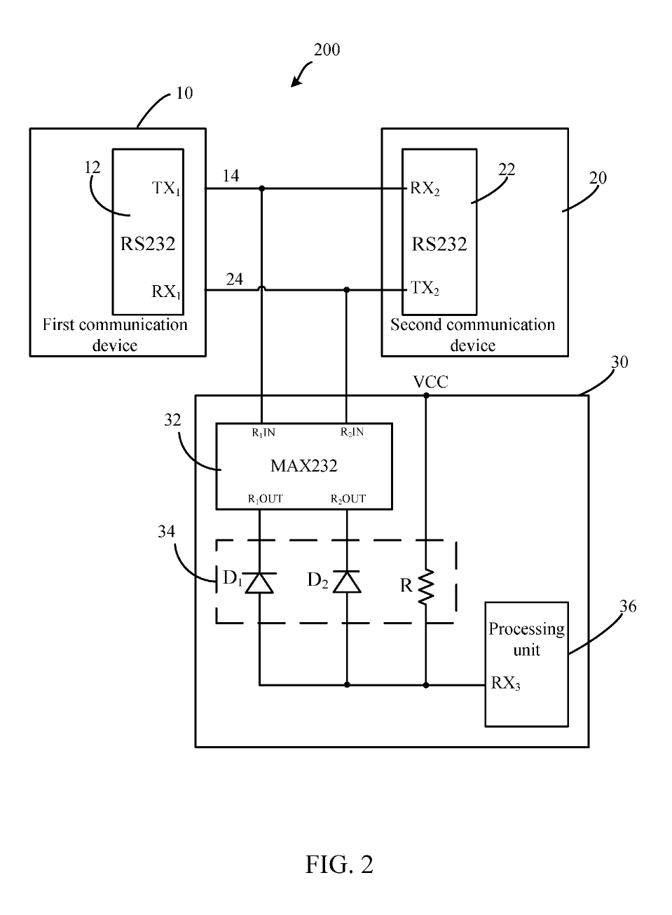

Referring to FIGS. 1 and 2, a serial communication system 100 includes a first communication device 10, a second communication device 20, and a monitor device 30. The communication devices 10, 20 transmit first signals in a first standard to each other in a half-duplex manner. The monitor device 30 is configured for detecting the first signals, and generating data corresponding to the first signals.

The first communication device 10 includes a first serial communication port 12. The second communication device 20 includes a second serial communication port 22 compatible with the first serial communication port 12. The serial communication ports 12, 22 can be Recommended Standard (RS) 232 (RS-232) ports, RS-485 ports, or RS-422 ports, etc. In the preferred embodiment, the serial communication ports 12, 22 are RS-232 ports. The first serial communication port 12 includes a first transmit terminal TX₁ and a first receive terminal RX₁. The second serial communication port 22 includes a second transmit terminal TX₂ connected to the first receive terminal RX₁ via a first cable 14, and a second receive terminal RX₂ connected to the first transmit terminal TX₁ via a second cable 24. The RS-232 interfaces transmit the signals in accordance with the Telecommunication Industry Association/Electronic Industries Association 232-F (TIA/EIA-232-F in short) standards, that is, voltage levels in voltage ranges from 5V to 15V and −5V to −15V. The RS-232 standard specifies that a logic 0 is represented by a voltage between 5V and 15V (first high-level voltage) and a logic 1 is represented by a voltage between −5V and −15V (first low-level voltage).

The monitor device 30 includes a convertor 32, a controller 34, and a processing unit 36. The convertor 32 is configured for receiving and converting the first signals into second signals in a second standard recognizable by the processing unit 36. The controller 34 is configured for generating third signals in the second standard according to the second signals. The processing unit 36 is configured for recognizing the third signals and generating data corresponding to the first signals. In the embodiment, the processing unit 26 is a computer that can generate data according to voltage levels of the third signals. Signal in the second standard recognizable by the processing unit 26 is transistor-transistor logic /complementary metal oxide semiconductor logic (TTL/CMOS in short) voltage levels in voltage ranges from 0V to 5V.

In the embodiment, the convertor 32 includes two receivers (not shown) for converting TIA/EIA-232-F voltage levels into TTL/CMOS voltage levels correspondingly. Thus, a MAX232 can be used as the convertor 32 in the embodiment. The MAX232 includes a first input terminal R₁IN connected to the first cable 14, a second input terminal R₂IN connected to the second cable 24, a first output terminal R₁OUT and a second output terminal R₂OUT connected to the controller 34. In detail, the MAX232 converts the first high-level voltage into a second low-level voltage between 0V to 0.4V, and converts the first low-level voltage into a second high-level voltage between 3.5V to 5V.

The controller 34 includes a unilateral-switch circuit 342 and a conductive element 344. A reference voltage is applied to a first terminal of the conductive element 344 whose second terminal is connected to a third receive terminal RX₃ of the processing unit 36. The conductive element 344 has a certain resistance and acts as a pull-up resistor. Thus, the conductive element 344 is preferably a resistor R. The unilateral-switch circuit 342, connected between the convertor 32 and the third receive terminal RX₃ of the processing unit 36, is configured for transmitting the second signals to the processing unit 36 when enabled, and letting the reference voltage be conducted to the processing unit 36 when disabled. Thus, the third signals are represented by a combination of voltage levels of the second signals and the reference voltage levels. The reference voltage is supplied from a reference voltage source VCC. A value of the reference voltage is lower than a minimum value of the second high-level voltage and is higher than a maximum value of the second low-level voltage. In the embodiment, the reference voltage is 3V, for example.

The unilateral-switch circuit 342 includes a first diode D1 and a second diode D2. A cathode of the first diode D1 is connected to the first output terminal R₁OUT of the convertor 32, and an anode of the first diode D1 is connected to the third receive terminal RX₃ of the processing unit 36. A cathode of the second diode D2 is connected to the second output terminal R₂OUT of the convertor 32, and an anode of the second diode D2 is connected to the third receive terminal RX₃ of the processing unit 36.

In operation, when the first communication device 10 needs to output a logic 0, the first serial communication port 12 outputs the first high-level voltage. The MAX232 converts the first high-level voltage into the second low-level voltage, as a result the first diode D1 is enabled (that is, opened) and conducts the second low-level voltage to the processing unit 36. Thus, the processing unit 36 generates the logic 0 according to the second low-level voltage accordingly. When the first communication device 10 needs to output a logic 1, the first serial communication port 12 outputs the first low-level voltage. The MAX232 converts the first low-level voltage into the second high-level voltage, as a result the first diode D1 is disabled (that is, closed), and the reference voltage is conducted to the processing unit 36 via the resistor R. Thus, the processing unit 36 generates the logic 1 according to the reference voltage.

The process is the same with the second communication device 20. When the second communication device 20 needs to output a logic 0, the second serial communication port 22 outputs the first high-level voltage. The MAX232 outputs the second low-level voltage, as a result the second diode D2 is enabled and conducts the second low-level voltage to the processing unit 36. Thus, the processing unit 36 generates the logic 0. When the second communication device 20 needs to output a logic 1, the second serial communication port 22 outputs the first low-level voltage. The MAX232 outputs the second high-level voltage, as a result the second diode D2 is disabled, and the reference voltage is conducted to the processing unit 36 via the resistor R. Thus, the processing unit 36 generates the logic 1.

In the preferred embodiment, the diodes D1, D2 are used as unilateral switches. In other embodiments, bipolar junction transistors (BJT), or metal-oxide semiconductor field effect transistors (MOSFETs), etc. can be used as unilateral switches to replace the first and second diode D1 and D2.

In other embodiments, when the first/second communication device 10/20 outputs a logic 0 in the form of the first high-level voltage, the processing unit 36 can generate a logic 1. When the first/second communication device 10/20 outputs a logic 1 in the form of the first low-level voltage, the processing unit 36 can generate a logic 0.

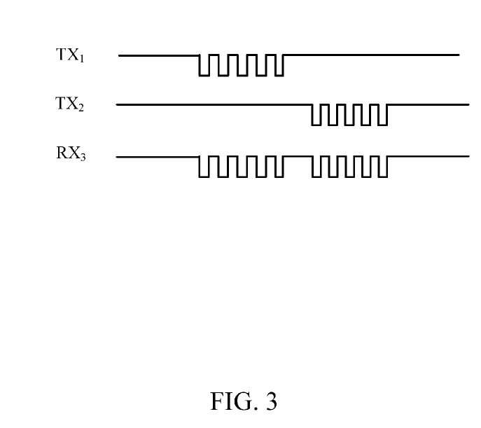

Referring to FIG. 3, in the above-described serial communication system 100, the first signals transmitted between the communication devices 10, 20 can be detected, and data corresponded to the first signals are generated and recorded. Furthermore, a transmitting timing of communication between the first and second communication devices 10, 20 can also be monitored.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A serial communication system, comprising:
a first and second communication devices for transmitting first signals in a first standard with each other;
a convertor for receiving and converting the first signals into second signals in a second standard;
a controller for generating third signals in the second standard according to the second signals; and
a processing unit for receiving the third signals and generating data corresponding to the first signals in responding the received third signals.

2. The serial communication system as claimed in claim 1, wherein the controller comprises a unilateral-switch circuit connected between the convertor and the processing unit, and a conductive element comprising a first terminal for receiving a reference voltage and a second terminal connected to the processing unit; the unilateral-switch circuit is for transmitting the second signals to the processing unit when enabled, and letting the reference voltage be conducted to the processing unit when disabled.

3. The serial communication system as claimed in claim 2, wherein the conductive element has a certain resistance.

4. The serial communication system as claimed in claim 3, wherein the conductive element is a resistor.

5. The serial communication system as claimed in claim 2, wherein the convertor comprises a first and second input terminals for receiving the first signals from the first and second communication devices respectively, and a first and second output terminals for outputting the second signals to the unilateral-switch circuit.

6. The serial communication system as claimed in claim 5, wherein the unilateral-switch circuit comprises a first diode comprising a cathode connected to the first output terminal of the convertor and an anode connected to the processing unit, and a second diode comprising a cathode connected to the second output terminal of the convertor and an anode connected to the processing unit.

7. The serial communication system as claimed in claim 6, wherein the reference voltage is lower than a minimum high-level output voltage of the convertor and higher than a maximum low-level output voltage of the convertor.

8. The serial communication system as claimed in claim 1, wherein the first signals in the first standard is represented by Telecommunication Industry Association/Electronic Industries Association-232-F voltage levels.

9. The serial communication system as claimed in claim 1, wherein the second signals in the second standard is represented by transistor-transistor logic/complementary metal oxide semiconductor logic voltage levels.

10. The serial communication system as claimed in claim 1, wherein the first and second communication devices communicate with each other in a half-duplex manner.

11. A monitor device for monitoring two serial communication devices transmitting first signals in a first standard to each other in a half-duplex manner, comprising:
a convertor for receiving and converting the first signals in the first standard into second signals in a second standard;
a controller for generating third signals in the second standard according to the second signals; and
a processing unit for receiving the third signals and generating data corresponding to the first signals in responding the received third signals.

12. The monitor device as claimed in claim 11, wherein the controller comprises a unilateral-switch circuit connected between the convertor and the processing unit, and a conductive element comprising a first terminal for receiving a reference voltage and a second terminal connected to the processing unit; the unilateral-switch circuit is for transmitting the second signals to the processing unit when enabled, and letting the reference voltage be conducted to the processing unit when disabled.

13. The monitor device as claimed in claim 12, wherein the conductive element has a certain resistance.

14. The monitor device as claimed in claim 13, wherein the conductive element is a resistor.

15. The monitor device as claimed in claim 13, wherein the convertor comprises a first and second input terminals for receiving the first signals, and a first and second output terminals for outputting the second signals to the unilateral-switch circuit.

16. The monitor device as claimed in claim 15, wherein the unilateral-switch circuit comprises a first diode comprising a cathode connected to the first output terminal of the convertor and an anode connected to the processing unit, and a second diode comprising a cathode connected to the second output terminal of the convertor and an anode connected to the processing unit.

17. The monitor device as claimed in claim 16, wherein the reference voltage is lower than a minimum high-level output voltage of the convertor and higher than a maximum low-level output voltage of the convertor.

18. The monitor device as claimed in claim 11, wherein the first signals in the first standard is represented by Telecommunication Industry Association/Electronic Industries Association-232-F voltage levels.

19. The monitor device as claimed in claim 11, wherein the second signals in the second standard is represented by transistor-transistor logic/complementary metal oxide semiconductor logic voltage levels.
